(19) United States
(12) Patent Application Publication
(10) Pub. No.: US 2008/0098825 A1
(43) Pub. Date: May 1, 2008

(54) Well flow meter

(76) Inventors: A. Russell Huntsman, Heber City, UT (US); Shirley Huntsman, Heber City, UT (US)

Correspondence Address: BRETT J. DAVIS, P. O. BOX 1909, SANDY, UT, 84091, US

(21) Appl. No.: 11/978,218

(22) Filed: Oct. 26, 2007

Related U.S. Application Data
(60) Provisional application No. 60/854,855, filed on Oct. 27, 2006.

(51) Int. Cl. G01F 1/34

(52) U.S. Cl. 73/861.42

(57) ABSTRACT

A flow meter that is easily and inexpensively installed in the casing of a well. The flow meter is able to improve the monitoring of private well water usage. The flow meter is typically disposed above an in-the-well pump and below an adapter that directs water outside of the well casing. The flow meter may be connected to a transmitter and antenna for broadcasting flow information to regulatory agencies using communication signals, such as radio frequency, infrared, or other communicating technology. The flow meter should optimally be located below the frost line inside of the casing in locations with cold temperatures. Power to operate the flow meter may be derived from a variety of sources, including a dedicated power line connected to a power source, such as a battery, power grid, or solar power. In addition, the flow meter may generate its own power from the flow of water through the meter.

### CROSS-REFERENCE TO RELATED APPLICATIONS

This application claims the benefit of U.S. Provisional Application No. 60/854,855, filed Oct. 27, 2006, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention.

The present disclosure relates generally to flow meters, and more particularly, but not necessarily entirely, to flow meters suitable for use with water wells.

2. Description of Related Art

A water well is an artificial excavation or structure put down by any method such as digging, driving, boring, or drilling for the purposes of withdrawing water from underground aquifers. Water wells are still common in the U.S. despite the prevalence of municipal water systems. In fact, most rural areas, and some cities, depend entirely on ground water as their source of water. In the U.S., drilled wells are the most prevalent well type as drilled wells can access water at a much deeper depth than other methods. Drilled wells are typically created using either top-head rotary style, table rotary, or cable tool drilling machines, all of which use drilling stems that are turned to create a cutting action. Most shallow well drilling machines are mounted on large trucks, trailers, or tracked vehicle carriages. Water wells typically range from 20 to 600 feet, but in some areas can go deeper than 3,000 feet.

Once a well has been drilled, a metal or plastic casing is typically inserted as a liner for the well bore. This casing prevents contamination of the water and also prevents cave-ins. A submersible pump attached to a bottom end of a pipe which is then lowered into the casing until the pump is submerged in the water at the bottom of the well. The pump may be connected by wires to a pump controller located above ground that is operable to control the operation of the pump. An adapter, such as a pitless adapter, may be used to direct the water in the pipe outside of the well casing. In areas prone to cold temperatures, the water pipes exiting a well casing may all be kept below the frost line of the ground.

Water wells may be operated by public and private entities as they are a convenient and low-cost source of water. However, well overdraft may occur when water is removed from a water aquifer at a faster rate than can be naturally replaced by rain or snow. The lowering of the water table may cause problems such as land subsidence, surface cracking, sinkholes on the surface, damage to the aquifer's water producing character due to compaction.

In the past, private water wells were largely unregulated. However, the rising demands on water resources, as well as water shortages, have prompted regulatory agencies to step-up their oversight of private water wells. Increasingly, regulatory agencies are requiring private well owners to install well flow meters for their wells. Existing well flow meters for measuring water flow from a well are typically designed for installation within a meter box located below the frost line but outside of the well casing. Other existing types of well flow meters are suitable for only above ground installation outside of the well casing. Both of these types of existing water meters are time-consuming to install and offer little or no protection from flooding and other problems.

Further, the presently available well flow meters are usually constructed by combining existing meters, meter boxes and component parts to create a retrofit unit that is labor intensive and time-consuming to install. Many of these well flow meters use outdated technology. Thus, while many regulatory agencies would like to monitor water use derived from underground sources, there is currently not a consistent, convenient and effective system available.

Further complicating the monitoring of water wells is their remote location. In a given rural area, water wells may be separated by large distances and the wells themselves may be inaccessible for a variety of reasons, including locked access points and uncooperative well owners.

The previously available devices are thus characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagrammatic view of an apparatus according to one embodiment of the present invention; and

FIG. 2 is a perspective view of the well flow meter depicted in FIG. 1.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “having,” “containing,” “characterized by,” and grammatical equivalents thereof are inclusive or open-ended terms that do not exclude additional, unrecited elements or method steps.

Applicant has discovered a flow meter that is easily and inexpensively installed into a well bore, and preferably, inside of the well casing. A flow meter pursuant to the present invention will improve the monitoring of private well water usage. The flow meter is typically disposed above a submersible water pump and below an adapter that channels water outside of the well casing. The flow meter may be connected to an above ground transmitter and antenna for broadcasting water flow information to regulatory agencies, or to persons with a need to know, using communication signals, such as communicating signals. The flow meter should optimally be located below the frost line inside of the casing. Power to the flow meter may be derived from a variety of sources, including a dedicated power line connected to a power source, such as a battery, power grid, or solar power. In addition, the flow meter may generate the necessary power from the water flow moving through the flow meter.

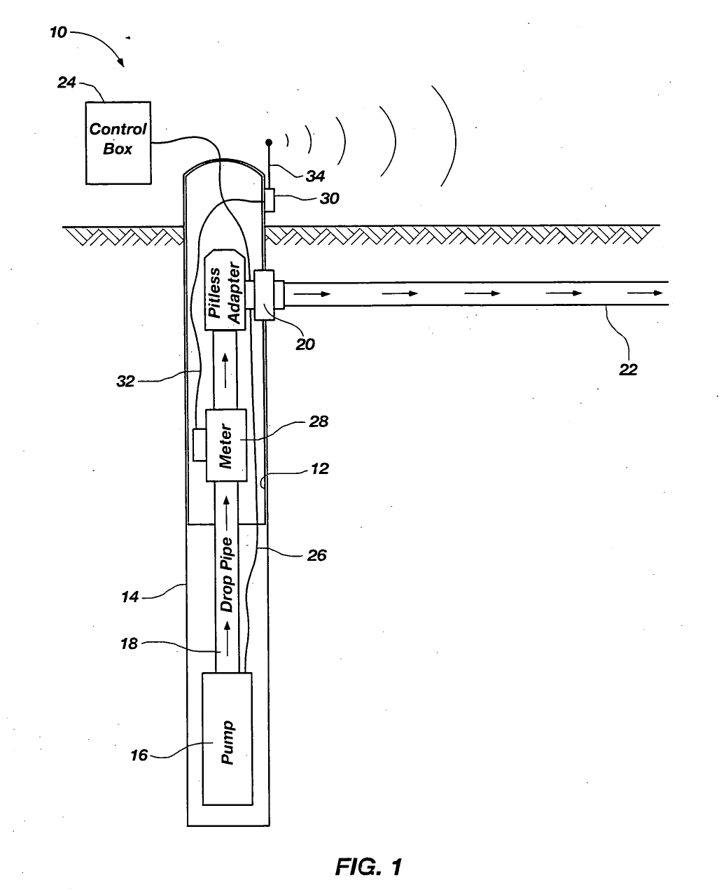

Referring now to FIG. 1, there is depicted an apparatus 10 pursuant to an embodiment of the present disclosure. The apparatus 10 includes a well casing 12 extending at least partway down a bore hole 14. It may be assumed that the bore hole 14 was created using any suitable drilling or boring technique as is known to one having ordinary skill in the art. The bore hole 14 may have a diameter of about three (3) inches or greater. The depth of the bore hole 14 is dependent upon the water level in the location where the bore hole 14 is located. Thus, it will be appreciated that the depth of the bore hole 14 may vary from location to location.

The well casing 12 may comprise a hollow metal or plastic structure typically installed while the bore hole 14 is being drilled. As stated above, the well casing 12 serves to prevent collapse of the bore hole 12 and the entrance of contaminants into the well. The bore hole 14 further serves to allow the placement of the necessary equipment to pump water from the well. The depth of the casing 12 may vary according to local regulations and geological conditions. The casing 12 may extend below the water level in the bore hole 12. The well casing 12 may extend above the ground by several feet.

Located at the bottom end of a pipe 18 is a submersible water pump 16. As is known to one having ordinary skill in the art, a submersible pump is a pump which is designed to operate underwater. The submersible pump 16 may have a hermetically sealed motor, that is, a system of mechanical seals is used to prevent the water being pumped from entering the motor and causing a short circuit. The capacity of the submersible pump 16 is dependent upon the size of the pipe 18 and the desired output of the well. The pipe 18 may be comprised of metal, plastic, or any other suitable material.

Disposed at the top of the pipe 18 is an adapter 20 for directing water to a pipe 22. The pipe 22 leads to the desired destination of the water, such as a irrigation system or residential water system. The adapter 20 is a device attached to the well casing below ground level. The adapter 20 is constructed so as to permit the flow of water from the pipe 18 to the externally located pipe 22. One suitable form of an adapter 20 is a known as a “pitless adapter.” In addition, the adapter 20 provides a sanitary and frost-proof seal for the casing 12 to prevent contaminates from entering the well.

A pump controller 24 is connected to the submersible pump 16 by a wire connection 26. The pump controller 24 may control the power to the pump 16 over the wire connection 26. The pump controller 24 may utilize a time clock to control the operation of the pump 16. The pump controller 24 may alternatively control the pump 16 on-demand or as needed. The operation of the pump controller 24 is well known to one having ordinary skill in the art, and many suitable pump controllers are available on the market for accomplishing the tasks described herein.

Interposed between the pump 16 and the adapter 20 is a flow meter 28. The flow meter 28 is operable to determine or measure the flow of water through the pipe 18 as generated by the pump 16. As used herein, the flow of water may be defined as the amount of water that travels past the flow meter 28. In one embodiment, the flow meter 28 may determine the flow of water by measuring the velocity of the water traveling through the pipe 18. This may be easily accomplished as the cross-sectional area of the pipe 18 is known. The velocity of the water through the pipe 18 may be measured using a rotary vane disposed in the stream of water flowing through the pipe 18.

In other embodiments of the present invention, the flow meter 28 may utilize other techniques for measuring the flow of water through the pipe 18. For example, the flow meter 18 may determine the flow rate of the water in the pipe 18 from mass flow, since the density of water is known. The flow meter 18 may determine the flow rate of the water in the pipe 18 using mechanical and electrical techniques. The flow meter 18 may determine the flow rate of the water in the pipe 18 from using differential pressure, positive displacement, and velocity and mass meters. Differential pressure devices include orifices, venturi tubes, flow tubes, flow nozzles, pitot tubes, and variable area meters. Positive displacement meters include piston, oval-gear, nutating-disk, and rotary-vane types. Velocity meters may comprise turbine, vortex, shedding, electromagnetic, and sonic designs. Mass meters include Coriolis and thermal types. Some of the above-mentioned designs may be more suitable for different deployments of the present invention as is known to one having ordinary skill in the art.

The flow meter 28 may comprise electronic circuitry to determine the flow rate of the water through the pipe 18. Typically, the output of the flow meter 28 is expressed in volume per unit of time. Suitable output from the flow meter 28 includes, without limitation, gallons per minute, cubic feet per second, and liters per minute. Other suitable output includes kilograms per hour, pounds per hour, and grams per minute or used to measure volume for other purposes.

Electronic circuitry within the flow meter 28 may send the flow information to a transmitter 30 over a wire 32 or wirelessly. The transmitter 30 may be connected to an antenna 34. The transmitter 30 may be a radio frequency transmitter. In operation, the transmitter 30 and antenna 34 are operable to send a signal to a receiver (not shown). The receiver may be operated by a regulatory authority, such as a water board or water district, or other persons or equipment with a need to know the flow information. Included in the transmitted signal may be information on water usage as determined by the flow meter 28. The information may also include identifying information, such as a well number, well location, well owner, and any relevant time periods for over which the flow of water was measured. Any suitable radio transmission technology and their related components may be utilized in order to carry out the features discussed herein.

Typically the information transmitted by the transmitter 30 and the antenna 34 will be logged in a centralized logging station (not explicitly shown) or other equipment. Appropriate repetition of transmissions may be necessary to ensure the receipt of the information at the centralized logging station or other equipment. Typically, only one-way communication is required for the present invention. However, two-way communication may be provided for acknowledgment and other purposes and is within the scope of the present disclosure. The transmitter 30 and antenna 34 may be designed to work on any suitable frequency, subject to governmental regulations. In one embodiment, the transmitter 30 and antenna 34 are able to transmit to a satellite communication system. In another embodiment, the transmitter 30 and antenna 34 utilize mobile phone or paging networks. It will be further noted, that in lieu of the transmitter 30 and 34, the information may be sent via wires. In one embodiment, the information is sent using power line carrier technology to the centralized logging station or other equipment. In still another embodiment, the information is sent using infrared signals. In still another embodiment, the information is sent using optical signals.

The flow meter 28 may interrupt the pipe 18. That is, the pipe 18 may comprise two sections that are attached to the flow meter 28. In particular, one section of the pipe 18 may be located above the flow meter 28 and lead to the adapter 20. The other section of the pipe 18 may be located below the flow meter 28 and lead to the pump 16.

Power to operate the flow meter 18 may be derived from a variety of sources, including a dedicated power line connected to a power source, such as a battery, power grid, or solar power. An internal battery may also be used in the flow meter 18. The flow meter 28 could also tap into the wire 26 that controls the pump 16. In addition, the flow meter 18 may generate the necessary power from water flowing past the flow meter 18 using a small generator.

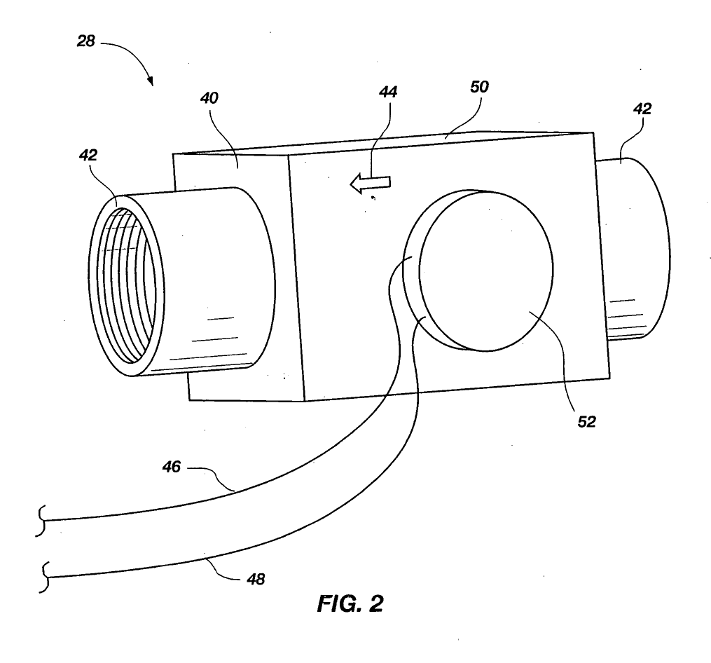

Referring now to FIG. 2, there is depicted a flow meter 28 which can be used in accordance with the present disclosure. The flow meter 28 includes a housing 40. The housing 40 may be constructed of metal, plastic or any other suitable material. The housing 40 includes a pair of threaded bores 42 at each end of the housing 40. The bores 42 are configured and adapted for receiving a threaded end of the pipe 18. Indicated on the flow meter 28 may be a flow directional indicator 44 which indicates the direction of installation for the flow meter 28 with respect to the direction of travel of the water through pipe 18. Extending from the housing 28 are wires 46 and 48. The wire 46 may be a communication wire for sending a signal having flow information therein to the transmitter 30 and the antenna 34. The wire 48 may provide power to the flow meter 28. The housing 40 also includes a main body portion 50. Contained in the main body portion 50 is the appropriate mechanical or electrical devices for measuring the flow through the flow meter 28. In addition, the main body portion 50 provides a fluid passageway for interconnecting the threaded bores 42 located on each end of the housing 40.

Attached to the housing 28 is a sub-housing 52 which contains the appropriate electronic circuitry for determining the flow through the flow meter 28. The electronic circuitry may be microprocessor based as is known to one having ordinary skill in the art. The sub-housing 52 may be removable from the main body 50 to provide access the electronic circuitry and the actual flow measuring device inside of the housing 50. It will be noted that the flow meter 28 is mounted in a vertical orientation when installed onto the pipe 18.

Those having ordinary skill in the relevant art will appreciate the advantages provided by the features of the present disclosure. For example, it is a feature of the present disclosure to provide a flow meter that is located within the bore of a water well. Another feature of the present disclosure is to provide such a flow meter that is able to broadcast flow information using radio frequency signals or other communicating technology. It is a further feature of the present disclosure, in accordance with one aspect thereof, to provide a flow meter located below the frost line and inside of a well casing.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An apparatus for measuring fluid flow for a well having a bore, the apparatus comprising:
a well casing for lining the bore of the well;
a pump located at a lower portion of the well;
a pipe extending upwardly from said pump;
an adapter disposed on a top portion of said pipe, said adapter allowing fluid in the pipe to pass through the well casing; and
a flow meter disposed in the bore of the well and between said pump and said adapter to thereby measure fluid flow through the pipe.

2. The apparatus of claim 1, wherein the pump is operable to pump water through the pipe.

3. The apparatus of claim 1, wherein the adapter is a pitless adapter.

4. The apparatus of claim 1, further comprising a pump controller connected to the pump by a wire connection, said pump controller controlling the pump through the wire connection.

5. The apparatus of claim 1, further comprising a transmitter for transmitting a signal containing information regarding fluid flow through the pipe.

6. The apparatus of claim 5, further comprising an antenna for broadcasting the signal.

7. The apparatus of claim 6, wherein said antenna is located outside of the well casing.

8. The apparatus of claim 1, wherein said flow meter comprises a rotary vane.

9. The apparatus of claim 1, wherein said flow meter is a differential pressure meter.

10. The apparatus of claim 1, wherein said flow meter comprises a venturi tube.

11. The apparatus of claim 1, further comprising a wire extending into the well casing and to the flow meter, said wire providing power for the flow meter.

12. An apparatus for measuring fluid flow inside of a well casing, said flow meter comprising:
a housing, said housing having a first bore and a second bore, the first bore and the second bore being interconnected by a fluid passageway;
said first bore being adapted to receive an upper end of a first pipe, a lower end of said first pipe being connected to a pump;
said second bore being adapted to receive a bottom end of a second pipe, a top end of said second pipe being connected to an adapter;
a flow measuring device disposed in or proximate said fluid passageway of the housing; and
a transmitter for transmitting a signal having information therein regarding fluid flow in the fluid passageway as determined by the flow measuring device.

13. The apparatus of claim 12, further comprising an antenna for broadcasting the signal.

14. The apparatus of claim 12, wherein said antenna is connected to the housing via a wire connection.

15. The apparatus of claim 12, wherein the first and second bores have a threaded inner surface.

16. The apparatus of claim 12, wherein the flow meter comprises a measuring device selected from the group consisting of a rotary vane, a differential pressure meter, and a venturi tube.

17. A method of measuring fluid flow from a well, said method comprising the steps of:
forming a first fluid passageway between a pump and an adapter;
installing a flow meter between the pump and the adapter such that the flow meter measures fluid flow through the first fluid passage;
installing the pump, the adapter, the fluid passageway and the flow meter into a well bore having a well casing; and
connecting the adapter to a second fluid passageway located outside of the well casing such that fluid in the first fluid passageway is able to exit the well casing into the second fluid passageway.

18. The method of claim 17, further comprising the step of installing the first fluid passageway in a vertical orientation inside of the well bore.

19. The method of claim 18, further comprising the step of installing a signal wire connected to the flow meter to an antenna located outside of the well casing.

20. The method of claim 18, further comprising the step of connecting the flow meter to a power source.
